(19) United States
(12) Patent Application Publication
(10) Pub. No.: US 2018/0209594 A1
(43) Pub. Date: Jul. 26, 2018

(54) LIGHTING PRODUCT FOR HANGING OR ATTACHING TO A SUPPORT STRUCTURE

(71) Applicant: Alpine Corporation, Los Angeles, CA (US)

(72) Inventor: Ninette Parisi, Woodstock, NY (US)

(73) Assignee: Alpine Corporation, Los Angeles, CA (US)

(21) Appl. No.: 15/414,580

(22) Filed: Jan. 24, 2017

(51) Int. Cl. F21L 4/08; F21V 21/08

(52) U.S. Cl. CPC F21L 4/08; F21Y 2115/10; F21V 21/08

(57) ABSTRACT

Provided is a solar lantern comprising: a) a housing; b) a source of light placed inside of the housing; c) a solar panel on top of the housing; d) a rechargeable battery for powering the source of light, the power source configured to be recharged by the solar panel; e) a connector for securing the lantern; f) a member configured for hanging the lantern from, a support structure that is positioned above the source of light; wherein the lantern is configured to either be hanged with the first member or secured with the connector.

### BACKGROUND SECTION OF THE INVENTION

Decorative items like lanterns are typically used to decorate and light up outdoor spaces, like gardens and patios. A problem with such decorative items is the lack of flexibility in positioning them in different manners in outdoor spaces.

### SUMMARY SECTION OF THE INVENTION

Provided is a solar portable item (of manufacture) comprising: a) a source of light; b) a solar panel; c) a rechargeable battery for powering the source of light, the rechargeable battery configured to be recharged by the solar panel; d) a connector, such as one positioned below the source of light, for securing the item to a first support structure that makes contact with a surface below the portable item; e) a member configured for hanging the item from a second support structure that is positioned above the source of light; and wherein the item is configured to either be hanged with the member or secured with the connector. The item can be a lantern. The solar panel can be on top of the item. The solar panel can be part of a solar panel housing, the solar panel housing placed on top of the housing. The rechargeable battery can be placed inside the solar panel housing. The source of light can be directly attached to the solar panel housing. The hanging member can be attached to the solar panel housing. The source of light can be placed below the solar panel. The solar portable item can further comprise a housing inside of which the source of light is placed, the housing configured to allow light from the light source to travel from inside of the housing to outside of the housing. The housing can comprise a plurality of bars that meet at a bottom of the housing. The housing can further comprise a cover placed on top of the bars. The item can further comprise a solar panel housing placed on the cover. The hanging member can be attached to the solar panel housing. The connector can be attached to where the bars meet. The second support structure can be a stake. The first support structure can be a hook. The source, of light can be an LED (Light Emitting Diode) light. The connector can be configured to be attached to the second support structure with a rotating motion. The connector and the second support structure can have complementary threads. The item can further comprise a solar panel housing placed on the cover or forming a central portion of the cover. The connector can be positioned below the lowest point of the source of light.

Provided is a solar lantern comprising: a) a housing; b) a source of light placed inside of the housing; c)a solar panel on top of the housing; d) a rechargeable battery for powering the source of light, the power source configured to be recharged by the solar panel; e) a connector positioned below the housing for securing the lantern to a stake for securing the lantern to ground; f) a member configured for hanging the lantern from a support structure; wherein the lantern is configured to either be hanged with the first member or secured with the connector. The lantern can further comprise a solar panel housing on top of which the solar panel rests, the solar panel housing containing the battery, and wherein the hanging member is attached to the solar panel housing.

Provided is a package comprising a container holding (i) a lantern with a) a housing; b)a source of light placed inside of the housing; c) a solar panel on top of the housing; d) a rechargeable battery for powering the source of light, the rechargeable battery configured to be recharged by the solar panel; e) a connector for securing the lantern to a stake for securing the lantern to ground; f) a member configured for hanging the lantern from a support structure; and further holding (ii) a stake for attaching to the lantern, wherein the lantern is configured to either be hanged with the first member or secured with the connector to the stake.

### DETAILED DESCRIPTION OF THE INVENTION

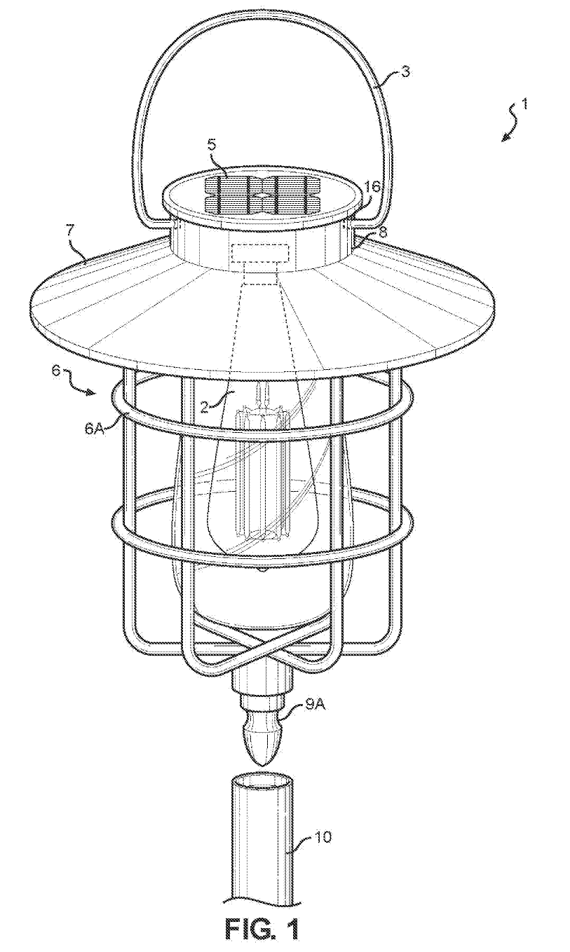

FIG. 1 illustrates a lantern and the top of a stake for attaching a lantern.

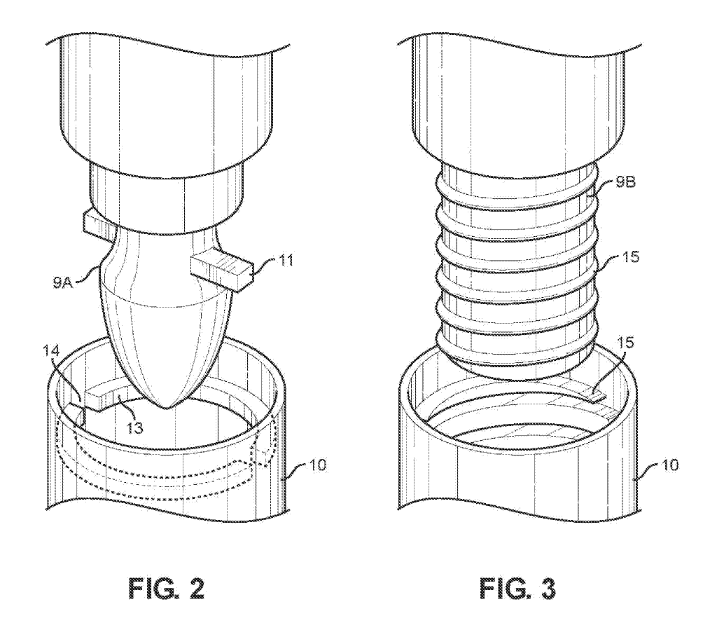

FIG. 2 illustrates a first connection mechanism for connecting the lantern to the top of the stake.

FIG. 3 illustrates a first connection mechanism for connecting the lantern to the top of the stake.

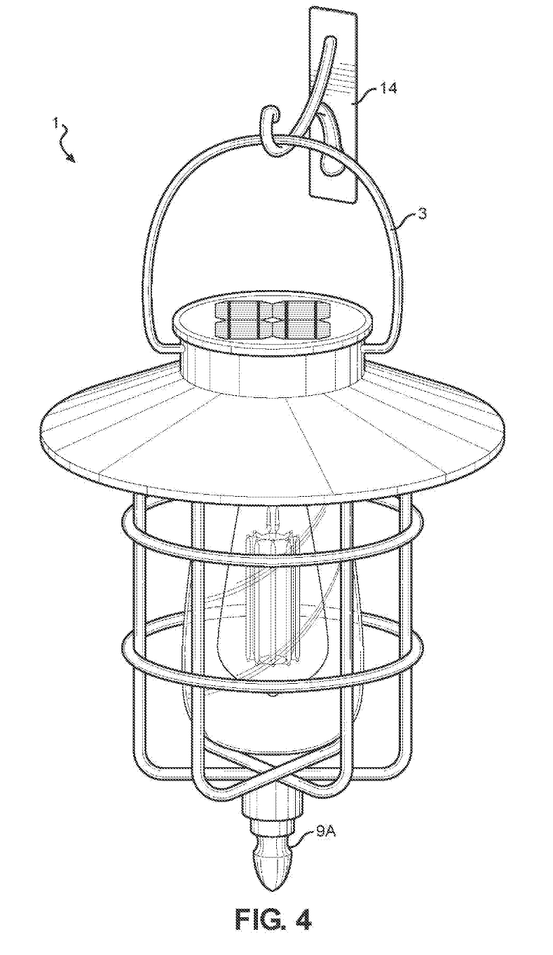

FIG. 4 illustrates hanging the lantern form a hook.

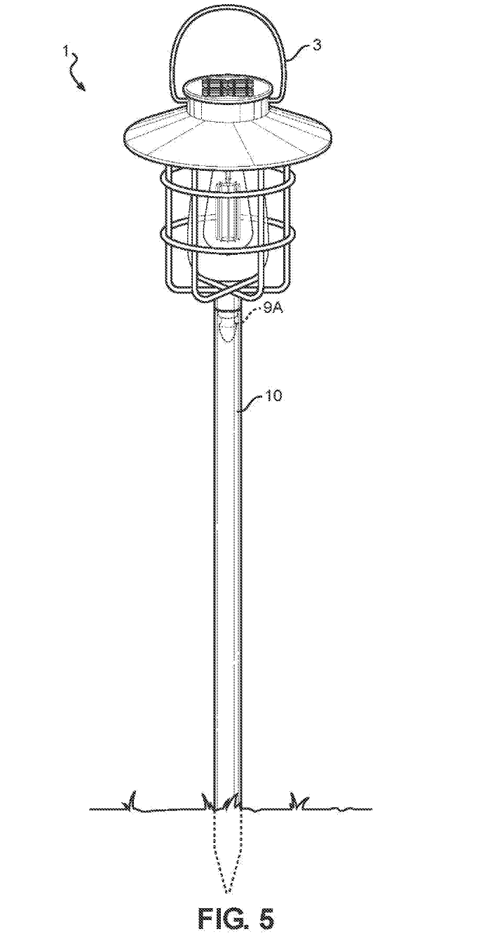

FIG. 5 illustrates securing the lantern to the ground with stake.

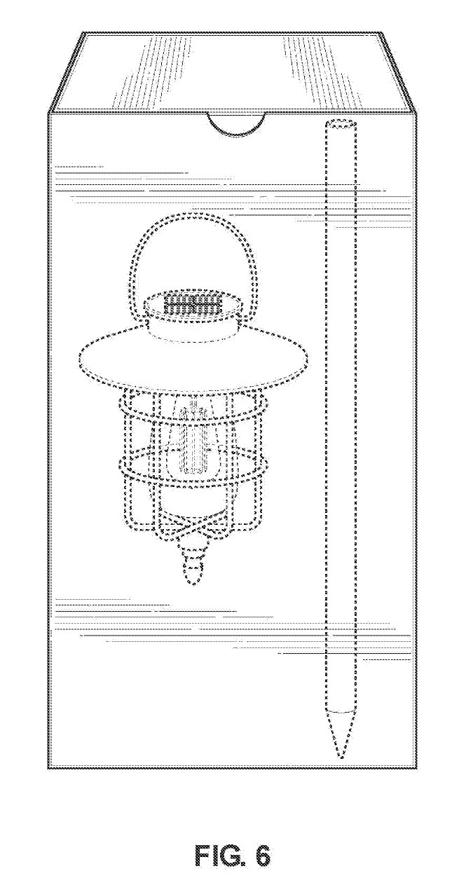

FIG. 6 illustrates a lantern and a stake in a package, in this case a box.

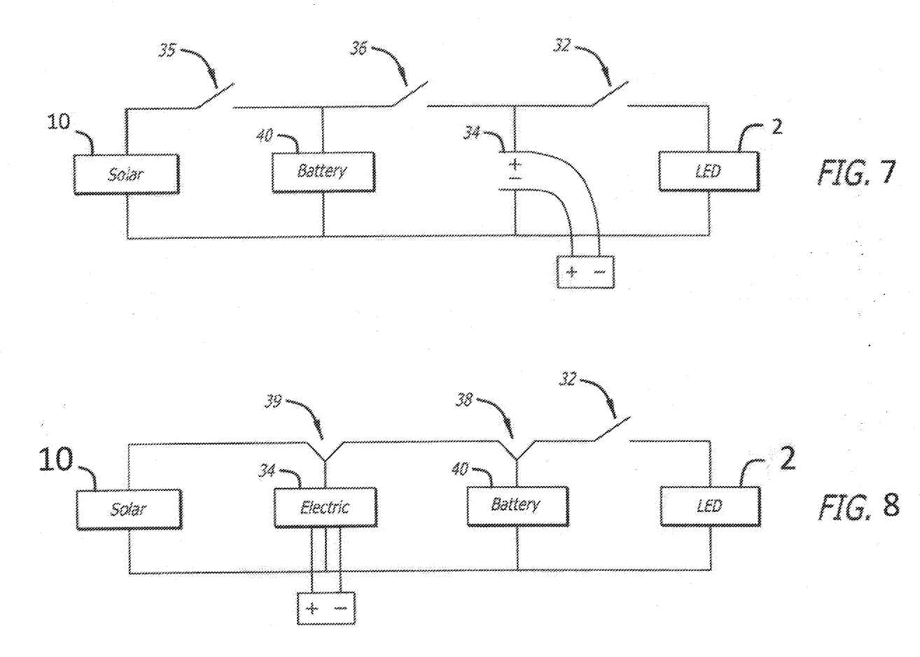

FIG. 7 illustrates a first exemplary circuitry for electrical components.

FIG. 8 illustrates a second exemplary circuitry for electrical components

### DETAILED DESCRIPTION OF THE INVENTION

The present invention provides a decorative item such as a lantern that can be either hanged from a support (such as a hook or wire) or attached to stake.

FIG. 1 illustrates lantern 1 and top portion of stake 10 before the attachment of the two to each other. The lantern 1 can have housing 6 inside of which a source of light 2 is placed. The housing 6 of the lantern 1 can be made from a plurality of bars 6A that curve (either entirely curved, or with a straight vertical portion that curves to form a horizontal bottom portion) arid meet at the bottom of lantern 1, and additional optional bars 6A that go around in a horizontal manner and/or angled manner. Alternatively housing 6 can be made from a transparent or translucent material, like clear plastic or glass. As illustrated in FIG. 1, connector 9 (in this case 9A) is placed at the bottom of lantern 1 in the position where the bars 6A that make the housing 6 meet. Connector 9 has a bottom portion configured to be attached to top of stake 10 or other support structure. A top cover 7 forms the top of, housing 6. The top cover 7 can be any geometric shape, such as rectangular, circular, or square. The top cover 7 can extend further to the periphery than bars of housing 6A. For example if the top cover 7 and rest of housing 6 are both circular, the top cover 7 can have a diameter that is longer in the horizontal plane than the bottom potion of housing 6 formed by bars 6A. The top cover 7 can have a descending angle from the center to the outside. Above the top cover 7 a solar panel housing 8 can be placed, on top, of which is solar panel 5, solar panel housing 8 can, either form a central portion of top cover 7 or be a different structure. Top cover 7 can have a central opening so that the source of light 2 can be directly attached to the solar panel housing 8. Solar panel housing 8 can have openings 16, such as diametrically spaced openings, for attaching hanging member 3. Solar panel housing 8 can be cylindrical or disc shaped. Solar panel housing 8 can have multiple electronic components 17, including rechargeable battery, ambient light, detector, processor, circuit board, wiring, resistors, capacitors, memory, and/or switches. The Source of light 2 can be directly attached to the solar panel housing. Hanging member 3 can be a bar with two ends (horizontally oriented) that loops and is configured to be attached to the diametrically spaced openings 16. The end of the bars of hanging member 3 can point to each other can be connected with an imaginary straight line. Hanging member 3 can be fixed in one place or be configured to pivot from a stowed and deployed position. FIG. 1 illustrates hanging member 3 in a deployed position. Other than lanterns, examples of items can include garden products, such as those having a housing in the shape of an animal with a source of light therein. The garden products can weigh less than 10 kg, such as less than 5 kg, and have a height of a maximum 0.5 meters.

FIGS. 2 and 3 illustrate exemplary mechanism for attaching lantern 1 to a support structure, here stake 10. In FIG. 2, connector 9A has securing members 11 that are diametrically spaced and protrude out like straight bars. Stake 10 has a ring 13 on the inside with openings 14 that complement the position of securing member 11. The connector 9A is placed in the cavity inside of stake 10 in such manner that protruding members 11 align against ring openings 14. After the protruding members 11 pass ring 13 from top of the ring 13 to bottom of ring 13, lantern 1 is rotated against stake 10 to secure lantern 1 to stake 10.

FIG. 3 illustrates connector 9B and the cavity inside of stake 10 having complementary threads 15, so that both can be removably and threadably attached to each other in the same manner as a screw and, a nut. Other securing mechanisms can be used, such snapping the connector into the stake. Connector 9 can come below the lowest surface of lantern 1 (providing a bottom surface that is unsuitable for resting on a surface) or alternatively be formed inside lantern 1 as a depression (providing for a flat bottom surface). The connection mechanism is configured to secure lantern 1 to stake 10.

FIG. 4 illustrates hanging lantern 1. Hanging member 3 can be used to hang lantern 1 from a hanging support 14, in this case a hook. Hanging member 3 is in a deployed position in this figure. Other supports can be used to hang lantern 1.

FIG. 5 illustrates lantern 1 attached to stake 10. Connector 9A is placed inside of top of stake 10, and secures lantern 1 to stake 10. Stake 10 can be placed in the ground (such as soil) to secure lantern 1.

FIG. 6 illustrates a package, in this case in the shape of a box, with lantern 1 and stake 10.

FIG. 7 illustrates an exemplary circuit diagram of control circuitry in the solar panel housing 8. There is provided solar panels 10, a rechargeable battery 40, and an optional connection to an, external source of electricity 34, such as an electrical outlet. The light source 2, such as a light-emitting diode (LED), is connected to the control circuitry. The flow of current is controlled by the on-off switch 32 and internal switches 35 and 36. In one embodiment, on-off switch 32 can be an internal switch. In another embodiment, on-off switch 32 can be an external killer switch.

FIG. 8 illustrates an alternate embodiment of an exemplary circuit diagram of control circuitry in the solar panel housing 8. The circuit in FIG. 8 operates substantially similar to the circuit in FIG. 7, except that the positions of the rechargeable battery 40 and external source of electricity 34 are reversed, and internal switches 35 and 36 are replaced with internal dual switches 38 and 39. Internal switches can turn on the lights when ambient light falls below a certain threshold.
1. Decorative item/lantern
2. light source
3. Hanging member
4. Hanging support
5. solar panel
6. Housing
6A. Bars of housing
6B. Top of housing
7. Cover (top)
8. Solar panel housing
9. Connector
9A. Connector
9B. Connector
10. Stake
11. Securing member
13. ring
14. opening in ring
15. threads
16. Openings in solar panel housing
17. Electronic components in the solar panel

What is claimed is:

1. A solar portable item comprising:
a) a source of light;
b) a solar panel;
c) a rechargeable battery for powering the source of light, the rechargeable battery configured to be recharged by the solar panel;
d) a connector for securing the item to a first support structure that makes contact with a surface below the portable item;
e) a member configured for hanging the item from a second support structure that is, positioned above the source of light; and
wherein the item is configured to either be hanged with the member or secured with the connector.

2. The solar portable item of claim 1, wherein the item is a lantern.

3. The solar portable item of claim 1, wherein the solar panel is on top of the item.

4. The solar portable item of claim 3, wherein the solar panel is part of a solar panel housing, the solar panel housing placed on top of the solar panel housing.

5. The solar portable item of claim 3, wherein the rechargeable battery is placed inside the solar panel housing

6. The solar portable item of claim 3, wherein the source of light is directly attached to the solar panel housing.

7. The solar portable item of claim 3, wherein the hanging member is attached to the solar panel housing.

8. The solar portable item of claim 1, wherein the source of light is placed below the solar panel

9. The solar portable item of claim 1, further comprising a housing inside of which the source of light is placed, the housing configured to allow light from the light source to travel from inside of the housing to outside of the housing.

10. The solar portable item of claim 9, wherein the housing comprises a plurality of bars that meet at a bottom of the housing.

11. The solar portable item of claim 10, wherein the housing further comprises a cover placed on top of the bars.

12. The solar portable item of claim 11, further comprising a solar panel housing placed on the cover or forming a central portion of the cover.

13. The solar portable item of claim 10, wherein the connector is attached to where the bars meet.

14. The solar portable item of claim 1, wherein the second support structure is stake.

15. The solar portable item of claim 1, wherein the first support structure is a hook.

16. The solar portable item of claim 1, wherein the source of light is an LED (Light Emitting Diode) light.

17. The solar portable item of claim 1, wherein the connector is configured to be attached to the second support structure with a rotating motion.

18. The solar portable item of claim 1, wherein the connector and the second support structure have complementary threads.

19. A solar lantern comprising:
a) a housing;
b) a source of light placed inside of the housing;
c) a solar panel on top of the housing;
d) a rechargeable battery for powering the source of light, the rechargeable battery configured to be recharged by the solar panel;
e) a connector positioned below the housing for securing the lantern to a stake for securing the lantern to ground;
f) a member configured for hanging the lantern from a support structure;
wherein the lantern is configured to either be hanged with the first member or secured with the connector to the stake.

20. A package comprising a container holding (i) a lantern with a) a housing; b) a source of light placed inside of the housing; c) a solar panel on top of the housing; d) a rechargeable battery for powering the source of light, the rechargeable battery configured to be recharged by the solar panel; e) a connector for securing the lantern to a stake for securing the lantern to ground: f) a member configured for hanging the lantern from a support structure; and further holding (ii) a stake for attaching to the lantern, wherein the lantern is configured to either be hanged with the first member or secured with the connector to the stake.
